(19) United States
(12) Patent Application Publication
(10) Pub. No.: US 2007/0286269 A1
(43) Pub. Date: Dec. 13, 2007

(54) Spectrum analyzer with remote control link

(76) Inventors: Gregory S. Hill, Santa Rosa, CA (US); Michael Richter, Santa Rosa, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/440,194

(22) Filed: May 23, 2006

(51) Int. Cl. H04B 17/00

(52) U.S. Cl. 375/228

(57) ABSTRACT

A spectrum analyzer has a measurement subsystem and a separable front panel (user) interface subsystem. The measurement subsystem includes a first power source, a high-frequency input port, a radio frequency receiver, an intermediate frequency section, a first processor, a first transceiver, and a first RF port coupling radio signals to and from the first transceiver. The user interface subsystem has a second power source, user input controls, a controller, a second transceiver, and a second RF port coupling the radio signals to and from the second transceiver.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

Spectrum analyzers are extremely useful measurement tools that can show signal information in the frequency domain that is not readily recognizable in the time domain. Oscilloscopes and other instruments show signal information in the time domain. For example, a modulated sinusoid signal is readily identified and measurable with a spectrum analyzer; however, it may be difficult to even detect that the sinusoid is modulated using an oscilloscope.

A common type of spectrum analyzer 100 is known as a superheterodyne spectrum analyzer, shown in FIG. 1. It operates in a similar fashion to a superheterodyne AM radio receiver, except the output goes to a display rather than a speaker; however, spectrum analyzers often have speaker outputs or a headphone jack so that the operator can listen to the signal being received and evaluated by the spectrum analyzer.

The spectrum analyzer 100 has a mixer 104 that mixes an input signal 118 with a signal from a local oscillator (“LO”) 114 to produce an intermediate frequency (“IF”) signal 110. An IF section 12 has a selectable IF filter bandwidth and may provide other functions, such as gain and signal processing, when the LO signal and RF input signal 118 produce an IF signal within the IF filter passband. The LO signal is produced by a swept or selectively tuned LO 14 driven by a sweep generator 16. The LO and input signal typically produce several mixing products, and the IF filter rejects all but the desired mixing product.

By knowing the LO frequency and IF frequency, one may calculate the frequency of the input signal. The LO 114 may be set to a fixed frequency, so that the spectrum analyzer monitors the input signal for a particular frequency, or the LO may be swept to identify the frequencies present on the input signal. For example, if an antenna is used to provide the RF input signal, the spectrum analyzer 100 can identify broadcast signals picked up by the antenna, and then analyze the broadcast signals for frequency, type of modulation, signal strength, and many other parameters.

A display 120, key farm (keypad) 122, and rotary pulse generator (“RPG”) 124 are integrated into the case 126 of the spectrum analyzer 100. A user enters inputs through the key farm 122 and RPG 124 that are detected and acted upon by a processor 128. The processor typically performs several functions, such as controlling the sweep generator 116 and IF section 112, formatting display data provided to the display 120, and monitoring the key farm and RPG for user inputs. A power source (e.g. battery) 130 is provided to allow use of the spectrum analyzer in applications where line power is not readily available. Spectrum analyzers often include a variable attenuator 132 to protect the mixer 104 from excessively high signals that might damage the mixer and a preselector 134 to block unwanted RF signals, particularly other RF signals that could mix with the LO signal to create a product at the IF. Those familiar with spectrum analyzers will appreciate that spectrum analyzers may have alternative block diagrams, and that several components are not separately shown for clarity and simplicity of illustration. Similarly, the illustrated components may provide a variety of functionality. For example, the processor 128 might provide an analog signal to drive the display 120, or alternatively a digital signal that is provided to a display driver (not separately shown).

The display is a flat-panel display, such as an LCD display, but is alternatively a CRT or other flat-panel display. The display typically shows power in dBm or other units versus frequency. The signal information of a spectrum analyzer is displayed in the frequency domain. Various techniques for measuring the degree of modulation, such as fast Fourier transforms, are typically included in the operating code (“firmware”) of the spectrum analyzer. Spectrum analyzers often allow the user to display the signal(s) being measured in a variety of formats, and may even include a time-domain (oscilloscope-like) display mode.

Many spectrum analyzers also include a port 136 that allows interfacing to a computer for remote control and automatic control of the spectrum analyzer, such as in an automated or semi-automated test-and-measurement system, or by having the spectrum analyzer at one location, and the computer at another.

Spectrum analyzers have been important test and measurement tools used in lab-bench and test-and-measurement environments for a long time. Spectrum analyzers have become more and more common outside of the traditional applications. Portable spectrum analyzers, which contain battery power supplies, allow making spectrum analyzer measurements in remote location. For example, a portable spectrum analyzer can be set up at a wireless transmitting tower to measure the signal(s) being transmitted, or set up in a remote location to identify intermittent broadcasts. However, remote use of the spectrum analyzer using a computer and interface port requires a suitable computer and associated software that adds to the bulk and complexity of the measurement system.

Thus, spectrum analyzers and techniques for using spectrum analyzers that avoid the problems of the prior art are desired.

### BRIEF SUMMARY OF THE INVENTION

A spectrum analyzer has a measurement subsystem and a separable front panel (user) interface subsystem. The measurement subsystem includes a first power source, a high-frequency input port, a radio frequency receiver, an intermediate frequency section, a first processor, a first transceiver, and a first RF port coupling radio signals to and from the first transceiver. The user interface subsystem has a second power source, user input controls, a controller, a second transceiver, and a second RF port coupling the radio signals to and from the second transceiver.

### BRIEF DESCRIPTION OF THE DRAWINGS

FIG. 1 is a diagram of a prior art spectrum analyzer.

FIG. 2A is a diagram of a spectrum analyzer with a wireless remote control link according to an embodiment of the invention.

FIG. 2B is a diagram of a spectrum analyzer with a cable remote control link according to another embodiment of the invention.

FIG. 3 is a flow chart of a method of operating a spectrum analyzer according to an embodiment of the invention.

### DETAILED DESCRIPTION OF THE EMBODIMENTS

### I. An Exemplary Spectrum Analyzer System

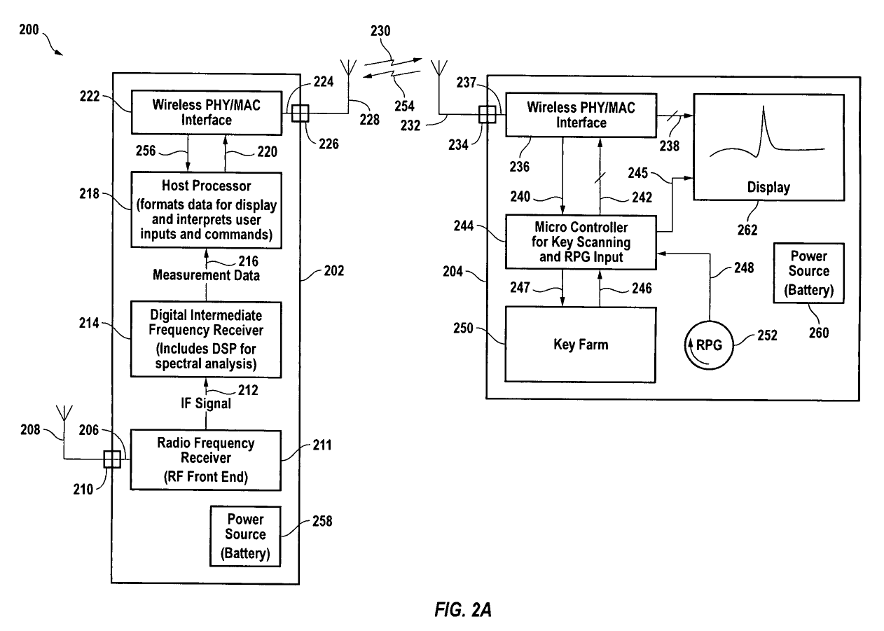

FIG. 2A is a diagram of a spectrum analyzer system 200 with a wireless remote control link according to an embodiment of the invention. The spectrum analyzer system has a measurement subsystem 202 and a separable front panel (user) interface subsystem 204. The spectrum analyzer receives an input signal 206 from a signal source 208, such as an antenna or other signal source, of which several are known in the art of spectrum analysis, at an input port 210. The input port 210 is typically a high-frequency connector, such as a BNC connector, a type-N connector, an APCT™-7 connector, an SMA™ 3.5 mm connector, a 1.85 mm coaxial connector, or other connector generally selected to operate over the frequency range of the spectrum analyzer or over the frequency range of interest. Such connectors are typically capable of efficiently coupling radio frequency (“RF”) signals and microwave (“MW”) signals (e.g. generally about 100 kHz to about 26.5 GHz) from the signal source 208 to a receiver 210 of the measurement subsystem 202.

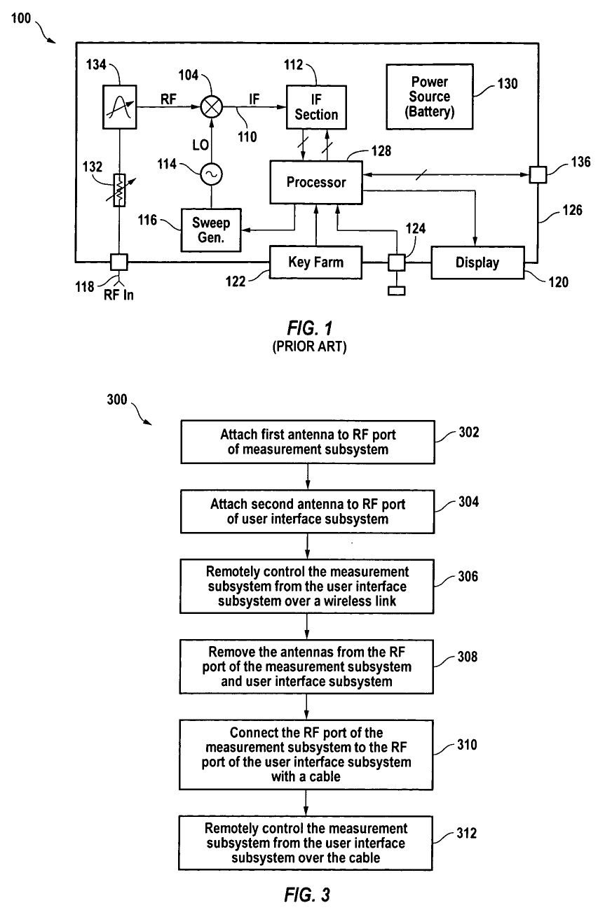

The receiver 211 typically includes a first converter (mixer), LO, and IF filter (not separately shown, see FIG. 1) and provides an IF signal 212 to an IF section 214, which in a particular embodiment is a digital IF receiver that includes a digital signal processor (“DSP”) (not separately shown). The DSP provides signal analysis functions, such as Fourier transforms of the IF signal. The IF section 214 produces measurement data 216 that is provided to a host processor 218. The host processor 218 formats the measurement data 216 for display and interprets user inputs and commands received from the user interface subsystem 204. The host processor formats and post processed data generated by the DSP in the IF section 214. Examples of the post processing include placement of a marker on the displayed trace, averaging of multiple traces, format of data into a waterfall display were a time axes is added to the amplitude and frequency data pairs. The host processor optionally provides additional signal analysis or signal processing functions. In an alternative embodiment, the signal and host processors are integrated into a single processor.

The host processor 218 provides formatted display data and other data 220 to a transceiver 222. In a particular embodiment, the transceiver 222 is a wireless physical/media access control (“PHY/MAC” or PHY-MAC”) interface, which are well known in the art of wireless networks, and is implemented in some embodiments as a single-chip solution. The transceiver 222 takes the data 220 from the host processor 218 and converts it to a radio signal 224. The radio signal is optionally encrypted to avoid non-authorized reception. In a particular embodiment, the radio signal 224 is a digital radio signal.

The measurement subsystem 202 has an RF port 226 connected to an antenna 228. The antenna 228 transmits the radio signal 224 from the transceiver 222 as radio waves 230 to another antenna 232 connected to an RF port 234 on the user interface subsystem 204. The user interface subsystem 204 also has a transceiver 236, which in a particular embodiment is a PHY/MAC interface. The transceiver 236 in the user interface subsystem 204 converts the radio signal to display data 238. The microcontroller 244 optionally provides a signal 245 to the display 262 to control intensity or other display characteristics, for example, and a signal 247 to the keyfarm 250 to turn key lighting on or off. The transceiver 236 also provides a signal 240 to the microcontroller 244 for updating the program code (e.g. bug fixes, user-selectable code functions, or firmware update). The transceiver 236 also receives data 242 from a controller 244. In a particular embodiment, the controller is a microcontroller and detects inputs 246, 248 from input keys 250 and an RPG 252, for example and sends them to the transceiver 236 for transmission to the measurement subsystem 202. In a particular embodiment, the input keys 250 are a keypad and associated keys commonly referred to as a “keyfarm.”

The data 242 from the controller 244 is converted by the transceiver 236 into a radio signal 237 transmitted to the measurement subsystem 202 as radio waves 254 received by the antenna 228 attached to the measurement subsystem 202 and transformed by the transceiver 222 into received data 256 that is supplied to the processor 218 to control the spectrum analyzer. For example, center frequency, resolution bandwidth, and other spectrum analyzer functions occurring in the measurement subsystem 202 are controllable from the user interface subsystem 204 through the antennas 228, 232 and radio waves 230, 254, which form a remote control link.

The measurement subsystem 202 has a power source 258, such as a battery and optional circuitry for charging the battery from line power. Some embodiments include the option of operating the measurement subsystem off of battery power or off of line power. A battery allows use of the measurement subsystem at a remote location where line power is not available. The user interface subsystem 204 has a separate power source 260, that it, separate from the power source 258 in the measurement subsystem 202. While this adds components and complexity to the spectrum analyzer system, it allows the user interface subsystem 204 to remotely control the measurement subsystem 202 over a wireless remote control link. The power source 260 provides electric power to the controller 244, transceiver 236 and display 262 of the user interface subsystem 204.

In a particular embodiment, the display is a liquid crystal display (“LCD”) that is light, thin, and consumes relatively little power. Other types of displays are alternatively used. Display data 238 is sent directly from the transceiver 236 to the display 262 without being routed through the controller 244. This reduces the processing load on the controller 244, allowing a small, low-power microcontroller to be used. Routing the display data 238 directly to the display 262 from the transceiver 236 also allows the controller 244 to be available to interpret data 246, 248 from the key input 250 or RPG 252, providing rapid response to user inputs that might otherwise be delayed if the controller 244 was processing display data. Alternatively, the signal 240 from the transceiver 236 includes display data, which is routed through the controller 244 to the display.

In a commercial application, the user might like to locate the measurement electronics (i.e. measurement subsystem 202) near the source of a physically difficult-to-access signal, such as the top of an antenna mast. The wireless link allows a user to control and read the spectrum analyzer from a more convenient location (e.g. from the ground) without having to run a cable or wire between the measurement subsystem 202 and the user interface subsystem 204.

### II. Another Exemplary Spectrum Analyzer System

FIG. 2B is a diagram of a spectrum analyzer with a cable 280 remote control link according to another embodiment of the invention. The cable 280 is attached to the RF connectors 226, 234 on the measurement subsystem 202 and user interface subsystem 204. The RF connectors are BNC connectors, TNC connectors, or other connectors suitable for connecting to antennas (see FIG. 2A, ref. nums. 228, 232) to transmit and receive radio waves (FIG. 2A, ref. nums. 230, 254). In other words, the cable 280 carries the radio signals 224, 237 to and from the transceivers 222, 236.

In a particular embodiment, the cable 280 has a selected amount of attenuation so that the signal strengths between the measurement subsystem and user interface subsystem are within a desired limit. For example, the cable has sufficient attenuation so that the radio signal 224 received by the transceiver 236 in the user interface subsystem 204 is about the same level as if it were received over the wireless link of FIG. 2A. In a particular embodiment, the cable 280 has attenuation of between about 30 dB and about 50 dB at the radio signal frequency(s) of interest. Alternatively, a conventional low-loss RF cable is used and an attenuator is placed in series between the transceivers 222, 236.

The cable provides an alternative remote control link to the wireless link illustrated in FIG. 2A. Radiation from a wireless link is susceptible to interception by unauthorized persons. Even if the radiations are not usable by unauthorized persons, merely detecting them might be undesirable in a covert situation, as it might identify that a spectrum analyzer is being used. For example, a spectrum analyzer can be used by a soldier in a hostile environment to detect transmissions used to set off an explosive device. A spectrum analyzer system as-shown in FIG. 2B allows the operator to carry the measurement subsystem 202 in a backpack while holding a relatively light, small, and inconspicuous user interface subsystem 204 in his hand. This facilitates covert operation of the spectrum analyzer system, reducing the chance that the user will be targeted by hostile forces and reducing the awareness of the surveillance.

The cable 280 provides a remote-control link between the user interface subsystem 204 and the measurement subsystem 202 with very low radiated emissions. Similarly a cable-based remote control link is less susceptible to radio interference that might be ambient or intentionally directed at the spectrum analyzer system to disrupt its operation.

Using the transceivers 222, 236 in the measurement subsystem 202 and the user interface subsystem 204 allows either a cable-based or wireless remote control link to be used. The radio signals transmitted between the measurement subsystem and the user interface subsystem are essentially the same in either embodiment. Additional signal processing when converting from a wireless link to a cable-based link is unnecessary. In other words, a single set of hardware communication devices (e.g. PHY/MACs) can be used with a variety of remote control links.

### III. An Exemplary Method of Operating a Spectrum Analyzer

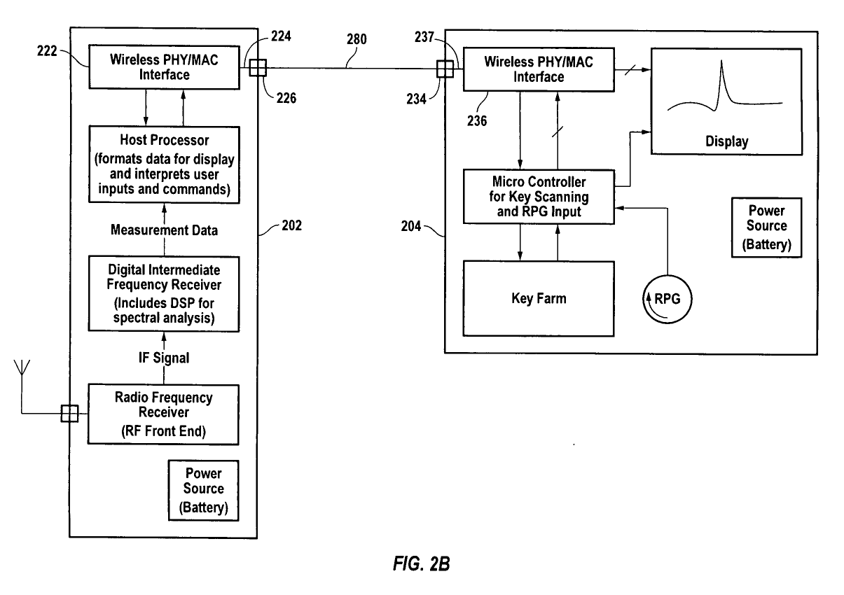

FIG. 3 is a flow chart of a method of operating a spectrum analyzer 300 according to an embodiment of the invention. A first antenna is attached to an RF port (see FIG. 2A, ref. num. 226) of a measurement subsystem of a spectrum analyzer (step 302). A second antenna is attached to an RF port (see FIG. 2A, ref. num. 234) of a user interface subsystem of the spectrum analyzer (step 304). The measurement subsystem is remotely controlled over a wireless link from the user interface subsystem according to user inputs (step 306). The first and second antennas are removed from the measurement subsystem and user interface subsystem (step 308), and the first RF port is connected to the second RF port with a cable (step 310). The measurement subsystem is remotely controlled over a cable-based link from the user interface subsystem according to user inputs (step 312).

While the preferred embodiments of the present invention have been illustrated in detail, it should be apparent that modifications and adaptations to these embodiments might occur to one skilled in the art without departing from the scope of the present invention as set forth in the following claims. For example, embodiments of the invention incorporate the host processor into the user interface subsystem. Similarly, the electronics in a user interface subsystem could be integrated to provide a very small form factor, and the display could be separate from electronics, such as a heads-up monocular display.

What is claimed is:

1. A spectrum analyzer system comprising;
a measurement subsystem having
a first power source,
a high-frequency input port,
a radio frequency receiver,
an intermediate frequency section,
a first processor,
a first transceiver, and
a first RF port coupling radio signals to and from the first transceiver;
a user interface subsystem having
a second power source,
user input controls,
a controller,
a second transceiver, and
a second RF port coupling the radio signals to and from the second transceiver.

2. The spectrum analyzer of claim 1 further comprising a remote control link between the first RF port and the second RF port.

3. The spectrum analyzer of claim 2 wherein the remote control link comprises a wireless link.

4. The spectrum analyzer of claim 3 wherein the wireless link includes a first antenna coupled to the first transceiver through the first RF connector and a second antenna coupled to the second transceiver through the second RF connector.

5. The spectrum analyzer of claim 2 wherein the remote control link comprises a cable.

6. The spectrum analyzer of claim 5 wherein the cable has a selected attenuation.

7. The spectrum analyzer of claim 6 wherein the selected attenuation is between about 30 dB and about 50 dB.

8. The spectrum analyzer of claim 5 further comprising an attenuator in series with the cable.

9. The spectrum analyzer of claim 1 wherein the first transceiver is a first PHY/MAC interface and the second transceiver is a second PHY/MAC interface.

10. The spectrum analyzer of claim 1 wherein the first power source comprises a first battery and the second power source comprises a second battery.

11. The spectrum analyzer of claim 1 wherein the user interface subsystem further comprises a display.

12. The spectrum analyzer of claim 11 wherein display data is provided from the second transceiver to the display.

13. The spectrum analyzer of claim 1 wherein the user input controls comprise key inputs and a rotary pulse generator.
